(19) United States
(12) Patent Application Publication
(10) Pub. No.: US 2006/0024212 A1
(43) Pub. Date: Feb. 2, 2006

(54) Analytical equipment cart

(76) Inventor: David S. Hwang, San Diego, CA (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/100,857

(22) Filed: Apr. 7, 2005

Related U.S. Application Data
(60) Provisional application No. 60/598,046, filed on Aug. 2, 2004.

(51) Int. Cl. B01L 9/00

(52) U.S. Cl. 422/104

(57) ABSTRACT

An analytical equipment cart that provides improved flexibility in the positioning of laboratory equipment and improved height adjustability includes a frame that supports an adjustable height platform or bench top, and a plurality of castors that allow the cart to be easily moved along a floor or other surface. The analytical equipment cart facilitates quick changing of work space as projects, personnel, and equipment changes, allowing reconfiguration of laboratory work space in minutes, and providing improved productivity, adjustability and optimal ergonomics.

### CROSS-REFERENCE TO RELATED APPLICATION

This application claims priority under 35 U.S.C. § 119(e) to U.S. Provisional Application No. 60/598,046 entitled ANALYTICAL EQUIPMENT CART, filed Aug. 2, 2004, by David S. Hwang, the entire disclosure of which is incorporated herein by reference.

### FIELD OF THE INVENTION

This invention relates to transportable laboratory furniture, and more particularly to an analytical equipment cart that provides ergonomic and portability advantages.

### BACKGROUND OF THE INVENTION

Laboratory furniture generally comprises steel cabinets that are permanently affixed to floors and walls of the laboratory, and chemical resistant bench tops affixed to the cabinets. Laboratory carts are typically designed to transport light equipment, such as glassware, and are not well suited, or at least not specifically adapted, for supporting heavy analytical instruments, such as gas chromatographs, high performance liquid chromatographs, and mass spectrometers, or the like, especially during use. Analytical equipment, such as mass spectrographs, gas chromatographs, high performance liquid chromatographs, and the like generally have been installed in a fixed position on laboratory furniture that is permanently affixed to the walls and floors of the laboratory. As a result, reconfiguring the laboratory to remove installed analytical equipment and install different analytical equipment, such as to accommodate a new project that requires different analytical equipment and/or a different arrangement of the analytical equipment, is a major laborious and time consuming operation. Further, flexibility is generally limited in the arrangement of equipment due to the fact that the laboratory furniture is permanently affixed to the walls and/or floors, requiring compromises in equipment arrangement and/or major renovations.

Another problem with conventional laboratory furniture used to support analytical equipment is that the analytical equipment is supported in a fixed position that represents a compromise with respect to the height of different users and with respect to operation and maintenance of the equipment. The best elevation is not necessarily the same for all users, and the best elevation for operation of the analytical equipment is not necessarily the best elevation for maintenance or repair of the equipment.

Accordingly, there is a need for easily transportable modular type laboratory furnishings that are capable of supporting heavy analytical equipment, such as mass spectrographs, and which are provided with features that support peripheral devices, tools, consumable supplies, and the like, which are needed for routine operation of the analytical equipment. Further, there is a need for laboratory furnishings that are capable of supporting heavy analytical equipment and which ergonomically accommodate operation by users of different heights, and which ergonomically facilitate maintenance and repair of the analytical equipment.

### SUMMARY OF THE INVENTION

The invention provides a single mobile unit or cart that provides improved flexibility in the positioning of laboratory equipment, and improved height adjustability, allowing analytical equipment to be easily repositioned within a laboratory or moved to another laboratory or storage area, and allowing a user to adjust the elevation of the analytical equipment supported on the cart to accommodate different equipment operators having different heights, and to more comfortably and ergonomically accommodate operation, maintenance and repair of the analytical equipment. These objectives and advantageous are achieved with an analytical equipment cart having a frame that supports an adjustable height platform or bench top, and having a plurality of castors that allow the cart to be easily moved along a floor or other surface.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a perspective view of the front and right side of an analytical equipment cart in accordance with an embodiment of the invention.

FIG. 2 is a perspective view of the frame for the analytical equipment cart shown in FIG. 1.

FIG. 3 is a perspective view of the front and left side of the analytical equipment cart shown in FIGS. 1 and 2.

FIG. 4 is an elevational side view of the left side of the analytical equipment cart shown in FIGS. 1-3.

FIG. 5 is an elevational view of the vacuum pump cabinet of the cart shown in the above figures, with the door of the vacuum pump cabinet open.

FIG. 6 is an elevational view of the solvent waste cabinet of the cart shown in the above figures, with the door of the solvent waste cabinet open.

### DETAILED DESCRIPTION OF PREFERRED EMBODIMENT

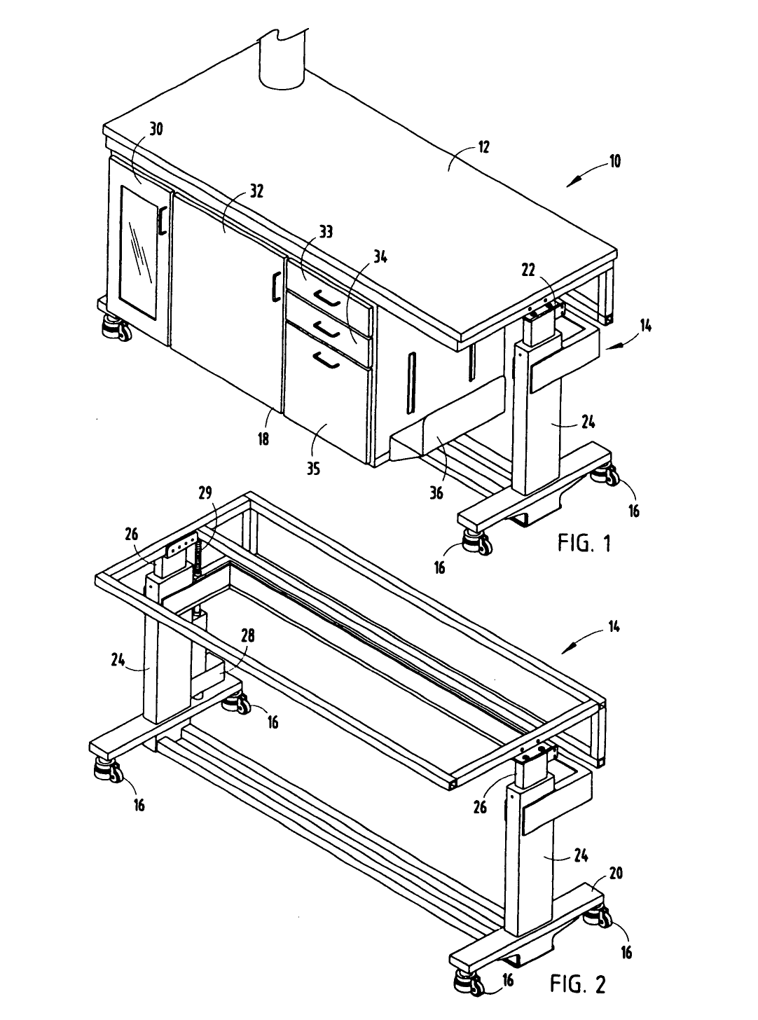

Shown in FIG. 1 is a perspective view of an analytical equipment cart 10 in accordance with an embodiment of the invention. Analytical equipment cart 10 includes a bench top 12 that provides a flat surface for supporting analytical equipment and/or other objects. Bench top 12 is mounted on an adjustable height frame 14, which allows bench top 12 to be raised or lowered as desired. Adjustable height frame 14 is set on a plurality of castors 16, which allow movement of analytical equipment cart in any desired direction. Suspended from or supported on the adjustable height frame 14 is a storage unit 18 for housing reagents, peripheral equipment, tools, consumables and/or the like, which may be needed for operation and/or maintenance of analytical equipment supported on bench top 12.

Shown in FIG. 2 is a perspective view of the adjustable height frame 14 for analytical equipment cart 10, without bench top 12 and without storage unit 18. Adjustable height frame 14 includes a lower or base frame 20, and an upper frame 22 that is moveable or repositionable in an upwardly or downwardly direction with respect to base frame 20. In the illustrated embodiment, base frame 20 includes upright hollow stanchions 24 at opposite ends of the base frame, and upper frame 22 includes dependent members 26 disposed within hollow upright stanchions 24. Specifically, upright stanchions 24 define a guide or track for linear movement of dependent members 26 upwardly and downwardly within the hollow defined in upright stanchions 24.

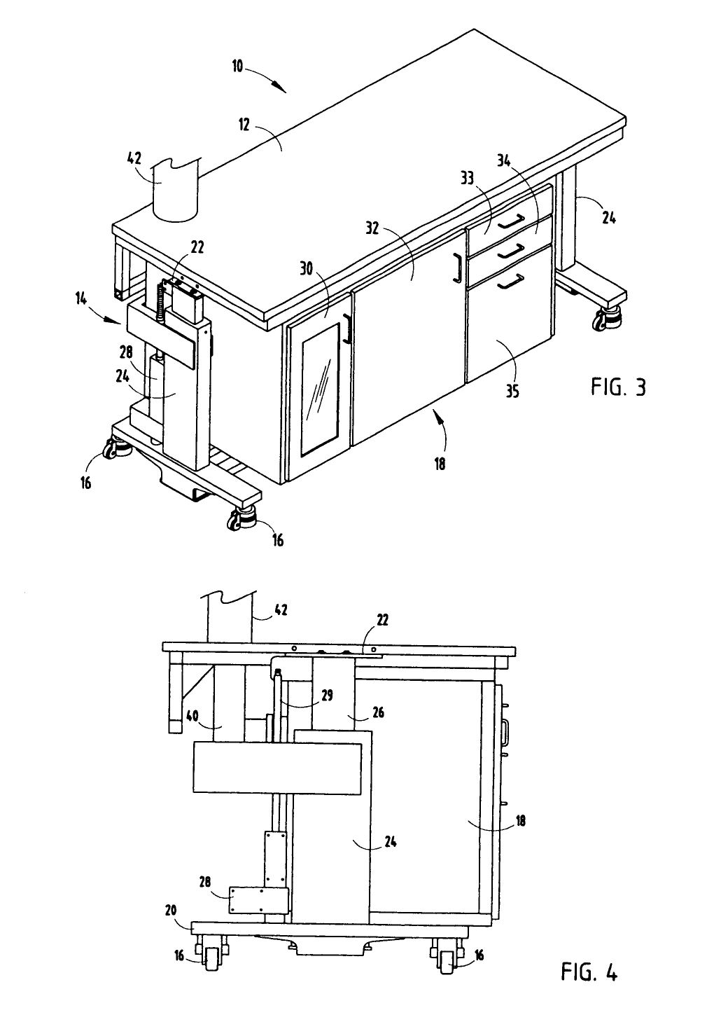

Upward and downward movement of upper frame 22 with respect to base frame 20 may be achieved by any appropriate means, such as a pneumatic lift system, a hydraulic lift system, or an electronic lift system. Use of an electric motor is preferred because it provides the greatest flexibility, ease of use, and ease of installation. Preferably, to facilitate smooth travel of upper frame 22 with respect to base frame 20, an electric drive motor 28 (FIG. 3) is provided for raising each member 26 with respect to stanchions 24. Specifically, the use of two motors that operate in tandem reduces the need for complex mechanical linkages that would ordinarily be employed to raise members 26 simultaneously to prevent binding.

Any of various mechanical devices or linear actuators may be employed for transmitting power from the output shafts of electric motors 28 to dependent members 26 for raising or lowering upper frame 22 with respect to base frame 20, such as a rack and pinion arrangement or a screw drive arrangement 29. Suitable tandem twin drive electronic screw lifts capable of lifting a 2000 pound load are commercially available and may be advantageously employed in certain embodiments of the invention.

Desirably, adjustable height frame 14 is designed to accommodate use of analytical equipment supported on the cart by individuals of various heights. An appropriate height adjustability is from about 30 inches to about 42 inches for the bench top height. However, this range of travel may be increased or decreased as desired for particular applications. Preferably, a suitable electronic drive system is selected to provide smooth, uninterrupted travel over the entire range in about 15 seconds or less, by activating an electronic switch located at the front of cart 10.

FIG. 3 is a perspective view, and FIG. 4 is an end view, of an analytical equipment cart 10 that is specifically designed for use with a mass spectrograph or similar analytical equipment. Storage unit 18 in this embodiment includes a ventilated solvent waste cabinet 30, a vacuum pump cabinet 32 and a plurality of drawers 33, 34, and 35, which may be used for storing tools, documentation, parts, etc. Storage unit 18 also includes an adjustable width computer shelf 36 for carrying any of a variety of central processing units that may be used for data acquisition, data analysis, and/or control of the analytical equipment and/or peripheral equipment (e.g., sample valves).

The ventilated solvent waste cabinet 36 includes a ventilation outlet port 38, and appropriate duct work 40 (FIG. 6) for connecting to a building exhaust system, such as via flexible conduit 42. Desirably, ventilated solvent waste cabinet 30 includes a pull-out tray 44 that comprises a chemical resistant, watertight pan. Desirably, pull-out tray 44 should be capable of supporting a relatively heavy load (e.g., at least about 100 pounds) when tray 44 is fully extended outwardly from cabinet 30. Desirably, solvent cabinet door 46 may be provided with a transparent panel 48 (e.g., a tempered safety glass vision panel) that allows viewing of the contents of the ventilated cabinet without opening door 46. This is desirably because it allows a user of the cart to minimize the time during which door 46 is open (by knowing exactly where to reach for a solvent or where to replace a solvent), thereby minimizing escape of solvent vapors from the ventilated solvent waste cabinet. Desirably, solvent cabinet 30 is sized to accommodate a 20 liter safety container or multiple four liter containers.

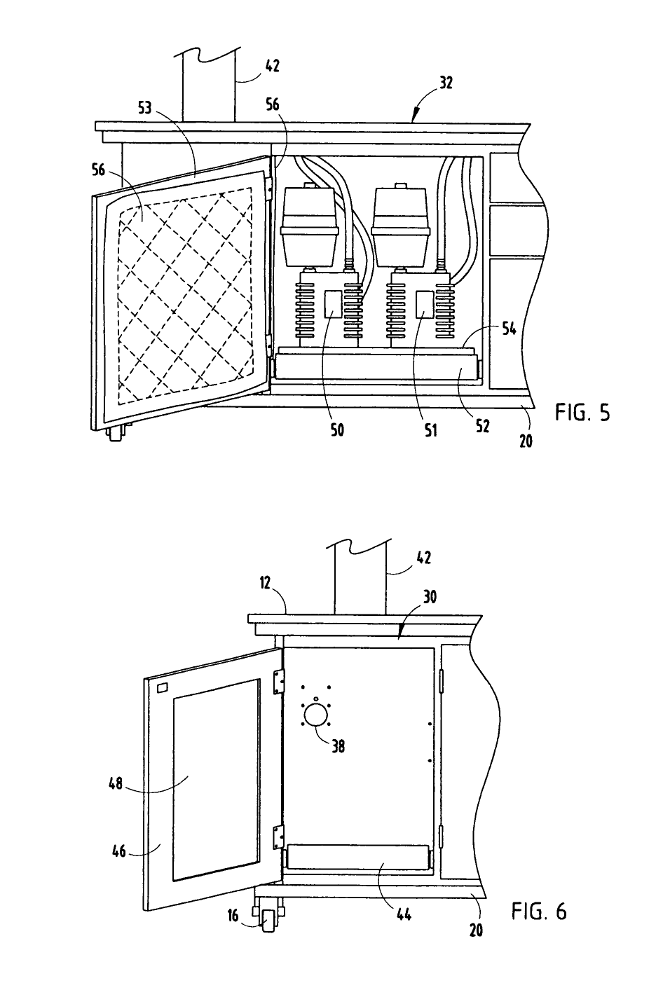

Vacuum pump cabinet 32 (e.g., for use with a mass spectrometer) is sized to house two rotary vane vacuum pumps 50 and 51 (FIG. 5). Vacuum pump cabinet 32 includes a pull-out tray 52 comprising a polypropylene watertight pan constructed to support 150 pounds when fully extended outwardly from the cabinet. A vibration isolation pad 54 (e.g., a foamed plastic or foamed rubber pad) located in tray 52 under pumps 50 and 51 absorbs vibrations that would interfere with proper operation of a mass spectrometer supported on bench top 12. Vacuum pump cabinet door 53 and side walls of cabinet 32 are lined with sound-absorbing, heat-deflecting liners 56. The back side of cabinet 32 is open to allow additional heat dissipation. As described and shown, the internal temperature of vacuum pump cabinet 32 is held to a maximum temperature of 88° F. with both pumps operating for eight hours.

Castors 16 typically have a relatively high load bearing capacity (e.g., at least about 500 pounds each), and are desirably provided with drop-down pins that release the weight of the cabinet and any equipment supported in or on the cabinet from the castors to provide a fixed bench position. Generally, each castor 16 comprises a wheel mounted on a swivel. This allows the horizontal wheel axle to be arranged in any direction with respect to cart 10, thereby facilitating movement of cart 10 in any direction.

Analytical equipment cart 10 facilitates quick changing of work space as projects, personnel and equipment changes. Analytical equipment cart 10 facilitates reconfiguration of the work space in literally minutes with the electronic lift. Also, analytical equipment cart 10 provides improved productivity. Research operations require different work surface heights for optimal ergonomics. Analytical equipment cart 10 allows samples to be easily loaded into a mass spectrometer positioned on bench top 12 without risk of injury or discomfort due to awkward movements by the operator. In particular, analytical equipment cart 10 allows the height of bench top 12 to be quickly changed as desired to meet individual needs.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. An analytical equipment cart, comprising:
an adjustable height frame supporting a laboratory bench top;
a plurality of castors attached to the frame, whereby the analytical equipment cart may be rolled along a surface; and
a storage unit supported on or suspended from the adjustable height frame, the storage unit including at least one ventilated solvent cabinet having a ventilation outlet port.

2. The analytical equipment cart of claim 1, wherein the ventilated solvent cabinet includes a pull-out tray.

3. The analytical equipment cart of claim 1, wherein the ventilated solvent cabinet includes a door having a transparent panel.

4. The analytical equipment cart of claim 1, further comprising a computer central processing unit shelf.

5. The analytical equipment cart of claim 1, further comprising a vacuum pump cabinet having a pull-out tray for supporting at least one vacuum pump.

6. The analytical equipment cart of claim 5, wherein a vibration isolation pad is located on the pull-out tray of the vacuum pump cabinet.

7. The analytical equipment cart of claim 6, wherein the vibration isolation pad is a foamed rubber or foamed plastic pad.

8. The analytical equipment cart of claim 5, further comprising sound-absorbing, heat-deflecting liners located on a cabinet door and side walls of the vacuum pump cabinet.

9. The analytical equipment cart of claim 1, wherein the frame comprises a base frame and an upper frame supported on the base frame, the upper frame being vertically moveable with respect to the base frame.

10. The analytical equipment cart of claim 9, further comprising at least one motor mounted on the base frame or upper frame, the motor having an output shaft linked to the linear actuator to facilitate raising or lowering of the upper frame with respect to the lower frame when the motor is activated.

11. An analytical equipment cart, comprising:
a base frame;
a plurality of castors attached to the base frame, whereby the analytical equipment cart may be rolled along a surface;
an upper frame supported on the base frame, the upper frame being vertically moveable with respect to the base frame;
a linear actuator for moving the upper frame with respect to the base frame; and
at least one motor mounted on the base frame or upper frame, the motor having an output shaft linked to the linear actuator to facilitate raising or lowering of the upper frame with respect to the lower frame when the motor is activated.

12. The analytical equipment cart of claim 11, further comprising a storage unit supported on the base frame or suspended from the upper frame, the storage unit including at least one cabinet or at least one drawer.

13. The analytical equipment cart of claim 12, wherein the storage unit includes a ventilated solvent cabinet.

14. The analytical equipment cart of claim 13, wherein the ventilated solvent cabinet includes a pull-out tray.

15. The analytical equipment cart of claim 13, wherein the ventilated solvent cabinet includes a door having a transparent panel.

16. The analytical equipment cart of claim 11, further comprising a computer central processing unit shelf.

17. The analytical equipment cart of claim 11, further comprising a vacuum pump cabinet having a pull-out tray for supporting at least one vacuum pump.

18. The analytical equipment cart of claim 17, wherein a vibration isolation pad is located on the pull-out tray of the vacuum pump cabinet.

19. The analytical equipment cart of claim 18, wherein the vibration isolation pad is a foamed rubber or foamed plastic pad.

20. The analytical equipment cart of claim 17, further comprising sound-absorbing, heat-deflecting liners located on a cabinet door and side walls of the vacuum pump cabinet.

21. The analytical equipment cart of claim 11, wherein the linear actuator is a screw drive.
